(19) United States
(12) Patent Application Publication
(10) Pub. No.: US 2007/0205898 A1
(43) Pub. Date: Sep. 6, 2007

(54) Air coil and manufacturing method thereof

(75) Inventors: Ru-Kuen Huang, Taoyuan Hsien (TW); Chieh-Cheng Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/705,436

(22) Filed: Feb. 13, 2007

(30) Foreign Application Priority Data
Mar. 3, 2006 (TW) 095107175

(51) Int. Cl. G08B 13/14

(52) U.S. Cl. 340/572.7

(57) ABSTRACT

A manufacturing method of an air coil with leads includes the following steps. Firstly, at least one conductive bump is formed on a base, and the base has at least one lead. Then, at least one end of at least one coil body is disposed on the lead, and is correspondingly contacted with the conductive bump. Finally, the shape of the conductive bump is changed to connect the lead and the coil body.

This Non-provisional application claims priority under 35 U.S.C. §119(a) on Patent Application No(s). 095107175 filed in Taiwan, Republic of China on Mar. 3, 2006, the entire contents of which are hereby incorporated by reference.

### BACKGROUND OF THE INVENTION

1. Field of Invention

The invention relates to an air coil and a manufacturing method thereof. In particular, the invention relates to an air coil with leads and a manufacturing method thereof.

2. Related Art

Coils are important electronic devices in circuits. As for an air coil, the connection between the coil body and metal leads in the prior art can be achieved by welding under a discharge of thousands of volts using a high-voltage spot-welding machine or by manual tin soldering. However, these two connection methods cannot satisfy the requirements of mass production. Although high-voltage spot-welding can provide sufficient connection strength and reliability, the welding needs to be performed point by point and requires precision positioning. Therefore, the production speed is slow, and the quality control is difficult. The manual operation, on the other hand, requires a huge amount of labor and time, and its quality control is also difficult.

Therefore, it is an important subject to provide an air coil with leads and the manufacturing method thereof which are suitable for mass production and easy to control the quality of products.

### SUMMARY OF THE INVENTION

In view of the foregoing, the invention is to provide an air coil with leads and a manufacturing method thereof which are suitable for mass production. The connection points between the coil body and the leads have good connection strength and reliability.

To achieve the above, a manufacturing method of an air coil with leads according to the invention includes the steps of: forming at least one conductive bump on a base having at least one lead; disposing at least one end of at least one coil body on the lead so that the end of the coil body correspondingly contacts with the conductive bump; and changing the shape of the conductive bump for connecting the coil body and the lead.

To achieve the above, the invention discloses an air coil including at least one lead and a coil body. At least one end of the coil body is connected to the lead. A conductive bump is formed on the coil body or the lead by printing, filling or sifting. Afterwards, the shape of the conductive bump is changed to connect the coil body and the lead.

To achieve the above, the invention also discloses a manufacturing method of an air coil-with leads. The manufacturing method includes the steps of: disposing at least one coil body on a base having at least one lead, wherein at least one end of the coil body is aligned to the lead; forming at least one conductive bump on the lead or the end of the coil body; and changing a shape of the conductive bump to connect the coil body and the lead.

The coil body is disposed between a pair of leads. Both ends of the coil body correspond to the pair of leads. At least one conductive material is formed at the connection points between the ends of the coil body and the pair of leads. The shape of the conductive material is changed to connect the coil body and the pair of leads.

As mentioned above, the manufacturing method of an air coil with leads of the present invention forms a conductive material at the connection point between the coil body and the leads by printing. Afterwards, the shape of the conductive material is changed to connect the coil body and the leads. In comparison with the prior art, the present invention does not require additional spot-welding machine or special equipments to welding the leads and the coil body. It only uses a mold plate, a tool and heating equipment for changing the shape of the conductive material, and then the coil body and the leads can be connected readily and precisely. Therefore, the manufacturing method of the present invention is suitable for mass production and at a lower manufacturing cost. Since the thickness of the mold plate and the size of the holes can precisely and uniformly control the size of each conductive material, the quality control becomes fairly easy. Furthermore, the melted conductive bumps are only attached to the vicinity of the connection part of the coil body and the leads during its deformation under heat such that no overflow or pollution to the leads, coil body or other parts occurs. This increases the connection strength and reliability between the coil body and the leads. One can therefore obtain an air coil with leads of good uniformity and yield for the convenience of subsequent assembly.

### BRIEF DESCRIPTION OF THE DRAWINGS

The invention will become more fully understood from the detailed description given herein below illustration only, and thus is not limitative of the present invention, and wherein:

FIG. 1 is a flowchart of a manufacturing method of an air coil with leads according to a preferred embodiment of the invention; and

FIGS. 2A to 2F show detailed steps in the manufacturing method of FIG. 1.

### DETAILED DESCRIPTION OF THE INVENTION

The present invention will be apparent from the following detailed description, which proceeds with reference to the accompanying drawings, wherein the same references relate to the same elements.

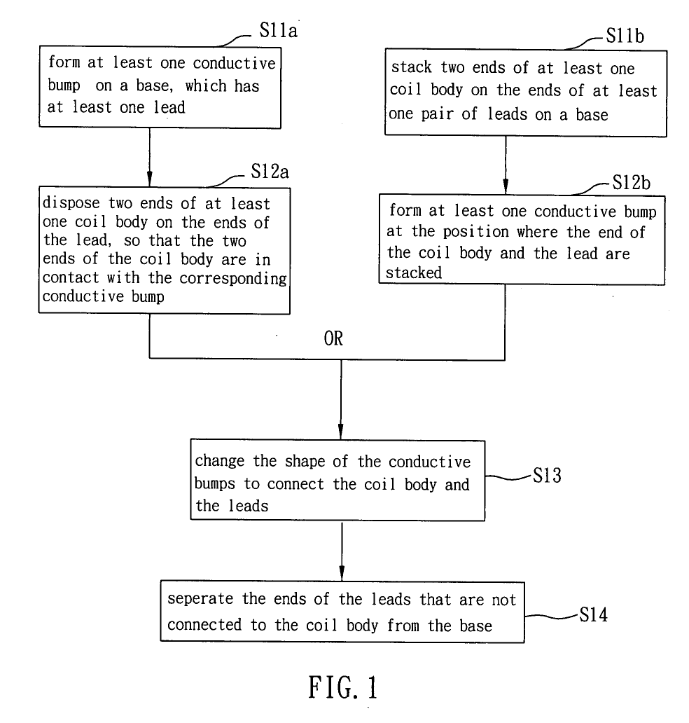

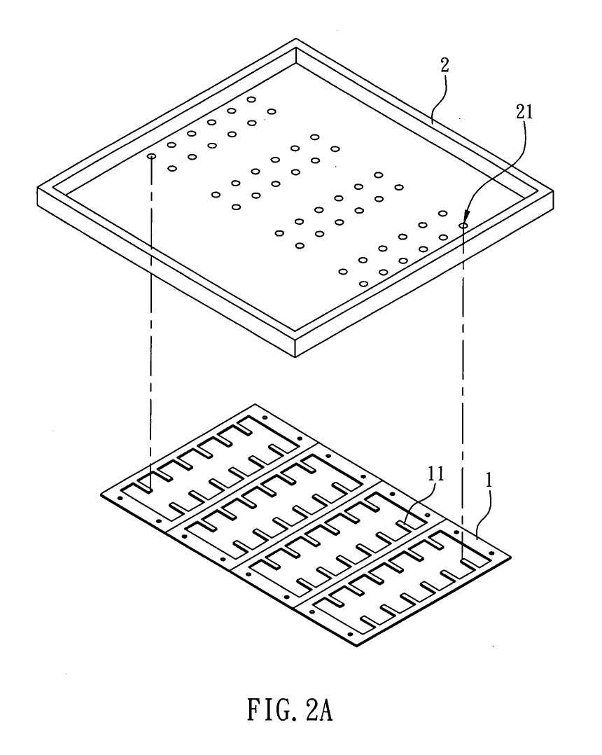

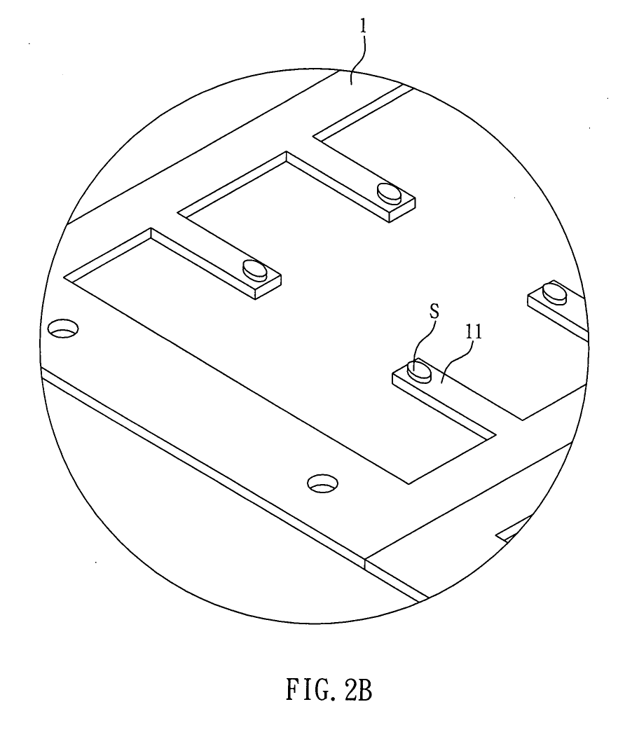

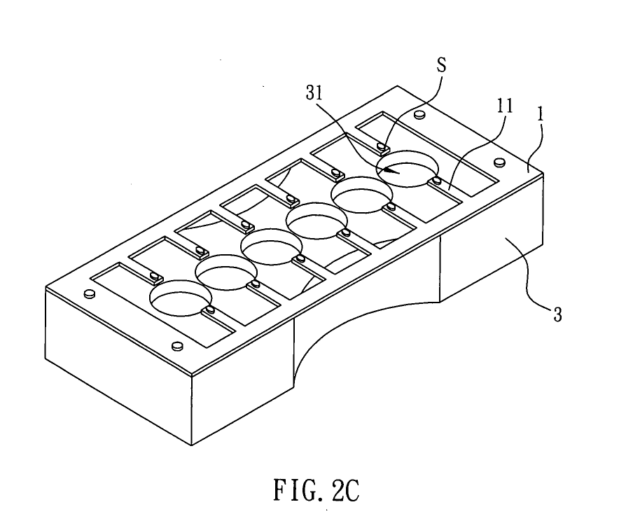

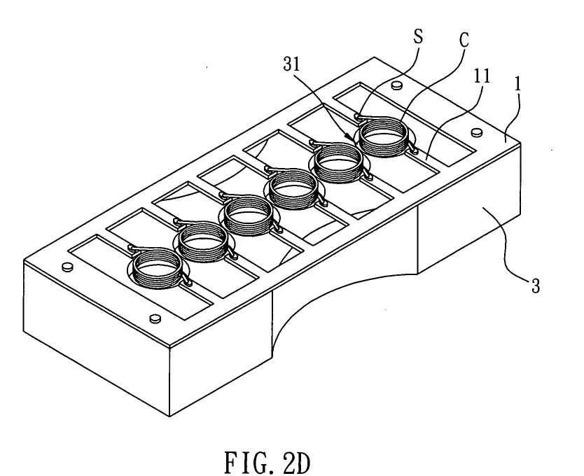

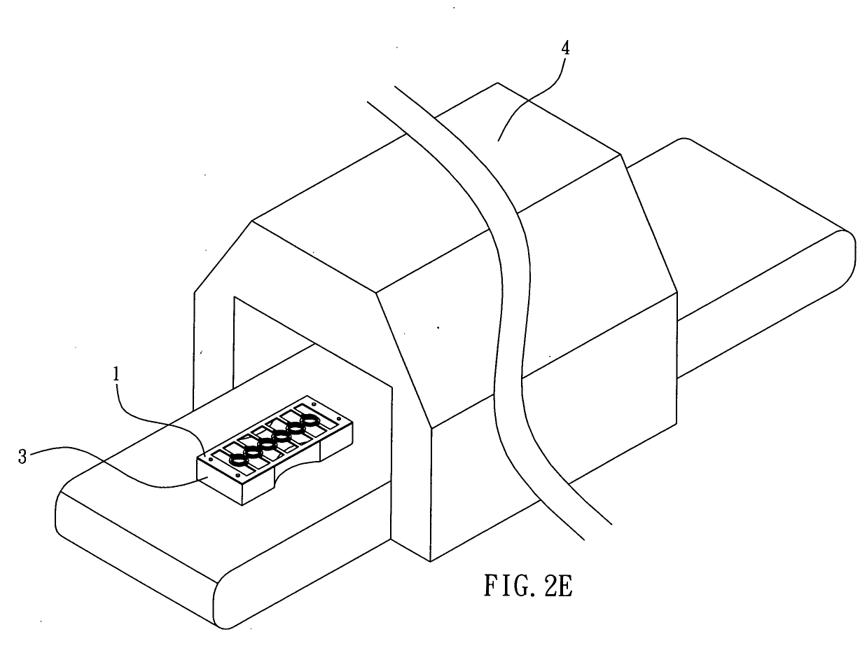

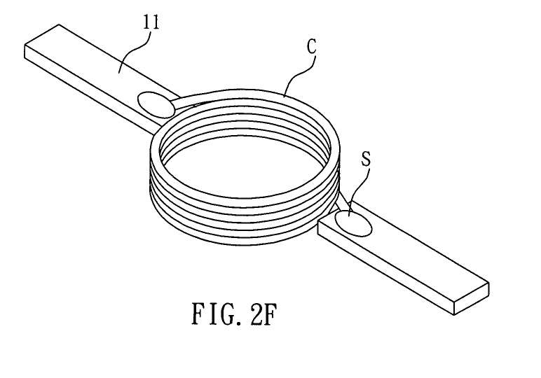

With reference to FIGS. 1 and 2A to 2F, a manufacturing method of an air coil with leads according to a preferred embodiment of the invention includes the following steps.

In step S11a, at least one conductive bump S is formed on a base 1, which has at least one pair of leads 11 (as shown in FIG. 2B). More explicitly, the base 1 is covered with a mold plate 2 with one or multiple holes 21 (as shown in FIG. 2A). The holes 21 correspond to the ends of the leads 11, respectively. The shape of the holes 21 can be circular, polygonal, elliptical, regular, or irregular. The conductive material is used to form conductive bumps S in the holes 21 by using the method of printing, filling or sifting. The conductive bumps S are in contact with the leads 11, and are preferably adhered or attached to the ends of the leads 11, respectively.

Moreover, the base 1 and the pair(s) of leads 11 can be integrally formed as a single piece in this embodiment. The material of the base 1 and the pair(s) of leads is not limited, and can be a metal or an alloy. The base 1 can even be a steel plate. The material of the mold plate 2 can also be a metal or an alloy. In this embodiment, a steel plate for the mold plate 2 is used as an example. The material of the conductive bumps S can be a solder paste, a solder ball, a thermally deformable material or a flexible material.

In step S12b, the two ends of each coil body C are disposed on the ends of each lead 11, respectively, so that the two ends of each coil body C are in contact with the corresponding conductive bumps S. In addition, the base 1 may be disposed on a tool 3 with a plurality of recesses 31 (as shown in FIG. 2C) before disposing the coil body C therein (as shown in FIG. 2D). Both ends of the coil body C can be precisely and rapidly aligned with the leads 11. Therefore, the reliability of the connections between the coil body C and the leads 11 can be greatly increased. Also, the production yield of the air core can be increased. Additionally, the interval between the lead pair 11 is preferably greater than the coiling diameter of the coil body C.

In step S13, the shape of the conductive bumps S is changed by heating or an ultrasonic method to connect the coil body C and the leads 11. More explicitly, the tool 3 conveying the coil body C, the conductive bumps S and the leads 11 is sent into heating equipment 4 and thus the shape of the conductive bumps S is deformed(e.g., as melted state). At the same time, the ends of the coil body C and the leads 11 are connected. After the deformed conductive bumps S are cured, the connection between the ends of the coil body C and the leads 11 is completed. The heating equipment 4 can be an oven, a hot air gun, a heater, or an infrared (IR) stove. At this case, the coil body C is fixed on the base 1.

When the conductive bumps S are heated, the melted conductive bumps S are only attached to the vicinity of the connection point between the coil body C and the corresponding leads 11, respectively. Therefore, the melted conductive bump S does not overflow or pollute the leads 11, the coil body C, or other parts. This helps to increase the connection strength and reliability between the coil body C and the leads 11. As the results, an air coil with leads of good uniformity and yield can be obtained for the convenience of subsequent assembly.

In step S14, the ends of the leads 11 that are not connected to the coil body C are separated from the base 1, thereby obtaining an air coil with leads (as shown in FIG. 2F). Thereof, when the base 1 is disposed with several pairs of leads 11, one can readily mass-produce air coils with leads precisely and in a stable way.

When the conductive bumps S are formed, the conductive bumps S are limited by the size of the holes 21 on the mold plate 2, and then the amount of each conductive bump S is controlled to be appropriate. Moreover, when the conductive bumps S are melted and deformed, there are no such problems as overflowing or polluting other parts of the leads 11, the base 1 or the coil body C. In addition, the manufactured air coil of the present invention can be used to an embedded inductor or a non-embedded inductor.

Please refer to FIG. 1. In the above-mentioned method of manufacturing an air coil with leads, steps S11a and S12b can be changed to steps S11b and S12b. In step S11b, both ends of at least one coil body C are stacked on the ends of at least one pair of leads 11 on a base 1. In step S12b, at least one conductive bump S is formed at the position where the end of the coil body C and the lead 11 are stacked. Afterwards, the above-mentioned steps S13 and S14 follow to complete the manufacturing procedures of the air coil with leads.

In summary, the manufacturing method of an air coil with leads of the present invention forms a conductive material at the connection point between the coil body and the leads by printing. Afterwards, the shape of the conductive material is changed to connect the coil body and the leads. In comparison with the prior art, the present invention does not require additional spot-welding machine or special equipments to welding the leads and the coil body. It only uses a mold plate, a tool and heating equipment for changing the shape of the conductive material, and then the coil body and the leads can be connected readily and precisely. Therefore, the manufacturing method of the present invention is suitable for mass production and at a lower manufacturing cost. Since the thickness of the mold plate and the size of the holes can precisely and uniformly control the size of each conductive material, the quality control becomes fairly easy. Furthermore, the melted conductive bumps are only attached to the vicinity of the connection part of the coil body and the leads during its deformation under heat such that no overflow or pollution to the leads, coil body or other parts occurs. This increases the connection strength and reliability between the coil body and the leads. One can therefore obtain an air coil with leads of good uniformity and yield for the convenience of subsequent assembly.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of an air coil, comprising steps of:
forming at least one conductive bump on a base with at least one lead; and
disposing at least one end of at least one coil body on the lead, wherein the end of the coil body correspondingly contacts with the conductive bump, so that the coil body and the lead are connected by the conductive bump.

2. The manufacturing method of claim 1, further comprising a step of separating an end of the lead, which is unconnected with the coil body, from the base.

3. The manufacturing method of claim 1, further comprising a step of fixing the base on a tool, wherein the coil body is disposed in at least one recess of the tool so that the end of the coil body is aligned to the lead.

4. The manufacturing method of claim 1, wherein the conductive bump is formed by way of printing, filling, or sifting.

5. The manufacturing method of claim 1, wherein a shape of the conductive bump is changed by heating or an ultrasonic method for connecting the coil body and the lead.

6. The manufacturing method of claim 5, wherein heating equipment is used to heat the conductive bump for changing the shape of the conductive shape, and the heating equipment is an oven, a hot air gun, a heater, or an infrared (IR) stove.

7. The manufacturing method of claim 1, further comprising steps of:
covering the base with a mold plate, wherein the mold plate has at least one hole corresponding to the lead; and
forming the conductive bump in the hole by way of printing, filling, or sifting.

8. The manufacturing method of claim 7, wherein the hole has a circular, polygonal, elliptical, regular, or irregular shape.

9. The manufacturing method of claim 1, wherein the material of the base and the lead comprises a metal or an alloy, and the base and the lead are integrally formed as a single piece.

10. The manufacturing method of claim 1, wherein the conductive bump is adhered or attached on the lead, and the material of the conductive bump comprises a solder paste, a solder ball, a thermally deformable material or a flexible material.

11. An air coil, comprising:
at least one lead; and
at least one coil body, at least one end of which is in contact with the lead;
wherein the coil body or the lead is formed with a conductive bump by way of printing, filling, or sifting so as to connect the coil body and the lead.

12. The coil of claim 11, wherein the lead is positioned on a base, and the base and the lead are integrally formed as a single piece.

13. The coil of claim 11, wherein a shape of the conductive bump is changed by heating or an ultrasonic method for connecting the coil body and the lead.

14. The coil of claim 11, wherein the material of the lead is a metal or an alloy.

15. The coil of claim 11, wherein the coil is used in an embedded inductor or a non-embedded inductor.

16. The coil of claim 11, wherein the conductive bump is adhered or attached on the lead.

17. A manufacturing method of an air coil, comprising steps of:
disposing at least one coil body on a base having at least one lead, wherein at least one end of the coil body is aligned to the lead; and
forming at least one conductive bump on the lead or the end of the coil body so that the coil body and the lead are connected by the conductive bump.

18. The manufacturing method of claim 17, further comprising a step of separating an end of the lead, which is not connected to the coil body, from the base.

19. The manufacturing method of claim 17, further comprising a step of fixing the base on a tool, wherein the coil body is disposed in at least one recess of the tool so that the end of the coil body is aligned to the lead.

20. The manufacturing method of claim 17, further comprising steps of:
covering the base with a mold plate, wherein the mold plate has at least one hole corresponding to the lead or the end of the coil body; and
forming the conductive bump in the hole by way of printing, filling, or sifting.
